(19) United States
(12) Patent Application Publication
(10) Pub. No.: US 2005/0199014 A1
(43) Pub. Date: Sep. 15, 2005

(54) Apparatus for producing glass particles deposit

(76) Inventors: Motonori Nakamura, Kanagawa (JP); Takashi Yamazaki, Kanagawa (JP); Toshihiro Ooishi, Kanagawa (JP)

Correspondence Address: MCDERMOTT WILL & EMERY LLP, 600 13TH STREET, N.W., WASHINGTON, DC, 20005-3096, US

(21) Appl. No.: 11/069,039

(22) Filed: Mar. 2, 2005

Related U.S. Application Data
(63) Continuation-in-part of application No. 10/197,536, filed on Jul. 18, 2002, now abandoned.

(30) Foreign Application Priority Data
Jul. 18, 2001 (JP) JP 2001-218173

(51) Int. Cl. C03B 37/018

(52) U.S. Cl. 65/413; 65/532; 65/421

(57) ABSTRACT

In an apparatus for producing glass particles deposit according to the present invention, a plurality of glass particle synthesis burners are placed on a front face of a reaction vessel, and at least one exhaust port is provided on a rear face of the reaction vessel. Two wall faces extending from both sides of the exhaust port and being in contact with two side faces of the reaction vessel are provided so that its contained angle is 90 degrees or less. Assuming that the shorter distance between the shortest distance from a rotation axis of a target rod to the side face of the reaction vessel and the shortest distance from the rotation axis of the target rod to the wall face is L, and the outer diameter of the glass particles deposit deposited on the target rod is d, L is greater than d.

### CROSS REFERENCE TO RELATED APPLICATIONS

This application is a Continuation-In-Part of application Ser. No. 10/197,536, filed on Jul. 18, 2002, which is incorporated herein by reference.

### BACKGROUND OF THE INVENTION

1. Field of the Invention

The present invention relates to an apparatus for producing glass particles deposit by depositing glass particles on an outer circumferential face of a target rod while relatively moving the target rod with respect to a glass particle synthesis burner in a reaction vessel. More particularly, the present invention relates to an apparatus for producing glass particles deposit in which the glass particles having not been deposited on the outer circumferential face of the target rod but floating within the reaction vessel can be exhausted out of the reaction vessel efficiently.

2. Description of the Prior Art

FIGS. 8A and 8B show one example of the prior art apparatus for producing glass particles deposit that is employed to produce glass articles such as an optical fiber.

A method for producing a glass particles deposit 5 by depositing glass particles on an outer circumferential face of a target rod I using this producing apparatus will be described below.

Within a reaction vessel 4, glass particles (referred to as the “soot”) are blown onto the outer circumferential face of the target rod 1 by burners 2 (this process is referred to as “soot deposition”). The target rod 1 is rotated around its central axis together with a supporting rod 3 by a rotation mechanism 7, so that the glass particles are deposited onto the entire circumference of the target rod 1. When the target rod 1 is movable up and down by means of a lift 8, the glass particles can be deposited over the entire length of the target rod 1. Since the lift 8 and the rotation mechanism 7 are operated continuously, the target rod 1 is moved in an upward or downward direction while being rotated, so that the glass particles are deposited onto the outer circumferential face of the target rod 1. Thus, the glass particles deposit 5 (referred to as “soot body”) is produced. Gas such as clean air is blown out of a gas port 18 during producing the glass particles deposit 5. The blown gas is passed around the glass particles deposit to be produced, and then flowed in a direction toward an exhaust port 17.

In producing the glass particles deposit using this producing apparatus, glass particles having not been deposited on the outer circumferential face of the target rod or the glass particles deposit are adhered within the reaction vessel. Since the reaction vessel is at high temperatures, an upward current occurs. Glass particles are blown in this upward current to flow to an upper part of the reaction vessel, and adhered on the upper part of the reaction vessel. In producing the glass particles deposit for a long time, a number of glass particles are adhered on the reaction vessel and peeled off in lump from the reaction vessel. An eddy occurs partially due to a flow of the fluid within the reaction vessel, so that glass particles that have once flowed to the exhaust port side can not be exhausted smoothly and remain within the reaction vessel. The peeled off lump of glass particles or the glass particles remaining within the reaction vessel are deposited on the glass particles deposit. Thereby, a portion where the lump or the glass particles were deposited excessively has a larger diameter than the other portions, whereby the outer shape of the produced glass particles deposit is irregular. When this glass particles deposit is vitrified to obtain a preform, the preform has irregularities or air bubbles which correspond to irregularities of the glass particles deposit.

U.S. Pat. No. 5,116,400 disclosed that while a burner array having a plurality of burners arranged in parallel to a target rod is moved with respect to the target rod, glass particles blown out of the burners are deposited on the target rod to produce the glass particles deposit. In order to form a uniform glass particles deposit, an air flow in the area between the burner array and the glass particles deposit is controlled to be relatively uniform over the entire length of the glass particles deposit, and substantially perpendicular to a central axis of the glass particles deposit.

In the invention of the above patent, air ports for causing the air flow are placed on both the outsides of the burners. The air flow from the air ports is blown toward the glass particles deposit. However, the air blown against the glass particles deposit is diffused over many directions, and is not flowed smoothly to an exhaust port. The diffused air may form an eddy. Owing to this eddy of the air flow, glass particles not deposited on the glass particles deposit are not exhausted rapidly. However, in the above patent, there is no consideration for this producing apparatus that glass particles are adhered on an inner face of the reaction vessel.

### SUMMARY OF THE INVENTION

It is an object of the present invention to provide an apparatus for producing glass particles deposit that can control a flow of fluid within the reaction vessel, and exhaust rapidly floating dusts such as glass particles that have not been deposited.

In the apparatus for producing glass particles deposit according to this invention, a target rod is held within a reaction vessel by a holding means. A plurality of glass particle synthesis burners are placed on a front face of the reaction vessel and directed toward an outer circumferential face of the target rod. The target rod or the burners can be relatively moved in parallel to a rotation axis of the target rod, glass particles synthesized by the burners are deposited one layer after another on the outer circumferential face of the target rod that is being rotated. At least one exhaust port is provided on a rear face of the reaction vessel. A fluid adjusting means has two wall faces extending from both sides of the exhaust port and being in contact with two side faces other than the front face and the rear face of the reaction vessel, with its contained angle of 90 degrees or less. Assuming that a shorter distance between a first shortest distance from the rotation axis of the target rod to the side face of the reaction vessel and a second shortest distance from the rotation axis of the target rod to the wall face is L, and an outer diameter of the glass particles deposit deposited on the target rod is d, L is greater than d. A plurality of first gas ports are provided at positions symmetrical with respect to a plane containing central axes of the burners and the rotation axis of the target rod, the positions being closer to the front face side of the reaction vessel than positions at which the side faces of the reaction vessel are contact with the wall faces. The first gas ports are directed toward the wall face on the same side.

In the apparatus for producing glass particles deposit, it is desirable that the plurality of exhaust ports are provided and a displacement adjusting unit for adjusting displacement through each exhaust port is provided.

Further, in the apparatus for producing glass particles deposit, it is desirable that a second gas port for blowing a gas flow is provided above the holding means of the target rod within the reaction vessel and in parallel to an upper face of the reaction vessel.

Moreover, in the apparatus for producing glass particles deposit, it is desirable that at least one of the exhaust ports is installed above positions where the glass particle synthesis burners are disposed.

Further, in the apparatus for producing glass particles deposit, it is desirable that the upper face of the reaction vessel is formed with an inclined face increasing in height at a constant rate from the front face of the reaction vessel to the rear face of the reaction vessel, and at least one of the exhaust ports is provided on an upper end portion of the rear face of the reaction vessel.

Moreover, in the apparatus for producing glass particles deposit, it is desirable that a gas heating unit for heating the gas to be supplied to the gas port is provided.

### BRIEF DESCRIPTION OF THE DRAWINGS

FIG. 1 is a schematic cross-sectional view of a glass particles deposit producing apparatus according to a first embodiment of the present invention, as seen from the side direction;

FIG. 2 is a schematic cross-sectional view of the glass particles deposit producing apparatus according to the first embodiment of the invention, as seen from the upper direction;

FIG. 3 is a schematic cross-sectional view of a glass particles deposit producing apparatus according to a second embodiment of the invention, as seen from the upper direction;

FIGS. 4A and 4B are schematic cross-sectional views for explaining a mounting position of a fluid adjusting means according to this invention;

FIG. 5 is an explanatory view showing a flow of glass particles synthesized by the burner within the reaction vessel;

FIG. 6 is a schematic cross-sectional view of a glass particles deposit producing apparatus according to a third embodiment of the invention, as seen from the side direction;

FIGS. 7A to 7D are explanatory views illustrating the mounting position of the fluid adjusting means within the reaction vessel and a condition of the fluid flow, as seeing the reaction vessel 4 from the upper direction;

FIG. 8A is a schematic cross-sectional view showing one example of the prior art glass particles deposit producing apparatus, as seen from the side direction; and

FIG. 8B is a schematic cross-sectional view showing one example of the prior art glass particles deposit producing apparatus, as seen from the upper direction.

### DETAILED DESCRIPTION OF THE INVENTION

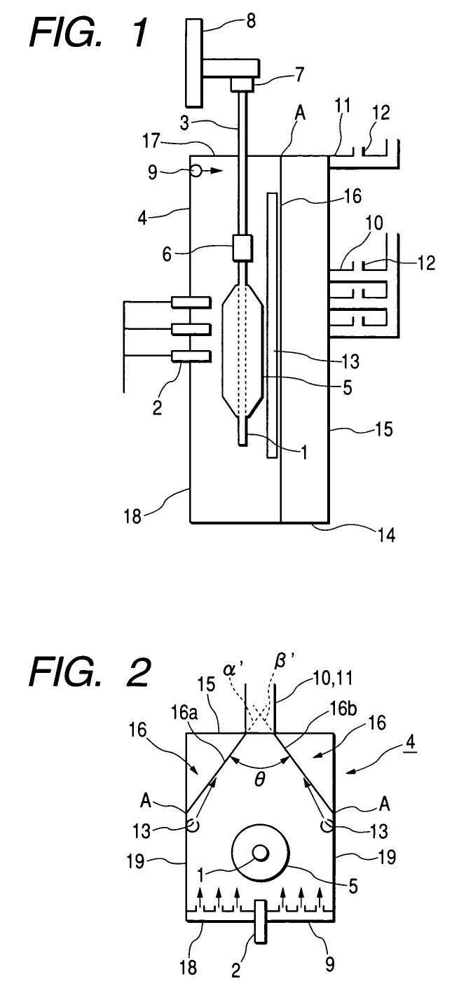

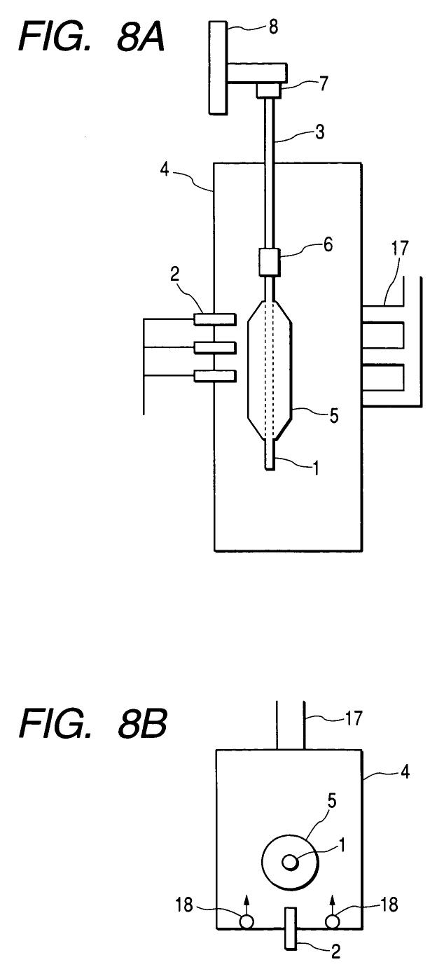

The present invention will be described below in more detail with reference to the drawings. In FIGS. 1 to 3, the same parts are designated by the same numerals as in FIGS. 8A and 8B, and the description of those same parts will be omitted. The arrow of FIGS. 1 to 3 indicates the gas blowout direction.

An apparatus for producing glass particles deposit according to a first embodiment of the present invention comprises glass particle synthesis burners 2, a supporting rod 3, a reaction vessel 4, a holding means 6, a rotation mechanism 7, a lift 8, and exhaust ports 10 and 11, and is employed to deposit glass particles on an outer circumferential face of a target rod 1. The reaction vessel 4 has a rectangular section. Within the reaction vessel 4, the target rod 1 is held by the holding means 6 connected with one end portion of the supporting rod 3. The supporting rod 3 extends outside the reaction vessel 4. The other end portion of the supporting rod 3 is connected with the rotation mechanism 7. The rotation mechanism 7 is also connected with the lift 8 for lifting the target rod 1. The plurality of glass particle synthesis burners 2 are arranged at a regular interval toward the target rod 1 on one side face 18 (hereinafter referred to as the front face) of the reaction vessel 4. The plurality of exhaust ports 10 and 11 are provided on the other side face 15 (hereinafter referred to as a rear face) opposite the front face 18 of the reaction vessel 4, and opposed to the burners 2, with the target rod 1 placed therebetween. The target rod 1 is rotated around its central axis by the rotation mechanism 7 together with the supporting rod 3. With the continuous operation of the lift 8 and the rotation mechanism 7, the target rod 1 is moved up or down while being rotated, so that glass particles are deposited on the outer circumferential face of the target rod 1.

The apparatus of the invention has a fluid adjusting means 16 for adjusting a flow of fluid within the reaction vessel 4. The fluid adjusting means 16 is provided almost vertically to a lower face 14 of the reaction vessel 4. This fluid adjusting means 16 has a pair of wall faces 16a and 16b for partitioning both side faces 19, 19 and the rear face continuous to both side faces 19, 19 of the reaction vessel 4. This pair of wall faces 16a and 16b consist of a pair of plate-shaped members extending from the lower face 14 to an upper face 17 within the reaction vessel 4. In the embodiment as shown in FIG. 2, the wall faces 16a and 16b of the fluid adjusting means 16 extend from both side faces 19, 19 of the reaction vessel 4 to end portions of the exhaust ports 10 and 11. The positions A, A where two wall faces 16a and 16b are contact with the side faces 19, 19 are mounting positions on the side faces 19, 19 of the fluid adjusting means 16. If the lines α′ and β′ connecting these two mounting positions and both end portions of the exhaust ports 10 and 11 are extended in an outside direction of the exhaust ports, these two lines α′ and β′ intersect with each other. The angle made by the intersection of these two lines α′ and β′ is defined as a contained angle θ between two wall faces. By changing the mounting positions A, A, the fluid adjusting means 16 can be set at arbitrary contained angle θ. The contained angle θ between two wall faces 16a and 16b of the fluid adjusting means is set at 90° or less, preferably 30° to 90°. In FIG. 1, one exhaust port 11 and three exhaust ports 10 are shown. However, the exhaust port 11 may not be provided depending on the producing conditions and the construction of the reaction vessel 4. The structure of the exhaust ports 10 may be taken at will in such a manner that a plurality of exhaust ports are arranged in a length direction of the target rod 1, or continuous slits are arranged in the length direction of the target rod 1. It is desirable to provide a plurality of exhaust ports in the number equal to or greater than the number of burners.

The mounting positions A, A of the fluid adjusting means 16 are set in the following way. The shorter one between the shortest distance from the center (rotational axis) of the target rod 1 to the side face 19 of the reaction vessel, and the shortest distance from the center (rotational axis) of the target rod to the wall face of the fluid adjusting means 16 is assumed to be L. Also, an outer diameter of the glass particles deposit 5 is assumed to be d. The fluid adjusting means 16 is set up such that L is greater than d (L>d). FIG. 4A shows a case where L is the shortest distance from the rotation axis of the target rod 1 to the wall face of the fluid adjusting means 16. FIG. 4B shows a case where L is the shortest distance from the rotation axis of the target rod 1 to the side face 19 of the reaction vessel 4. With this fluid adjusting means 16, the space within the reaction vessel 4 is constructed so that distance between the wall faces of the fluid adjusting means 16 becomes smaller from the mounting position of the side face 19 toward the exhaust port.

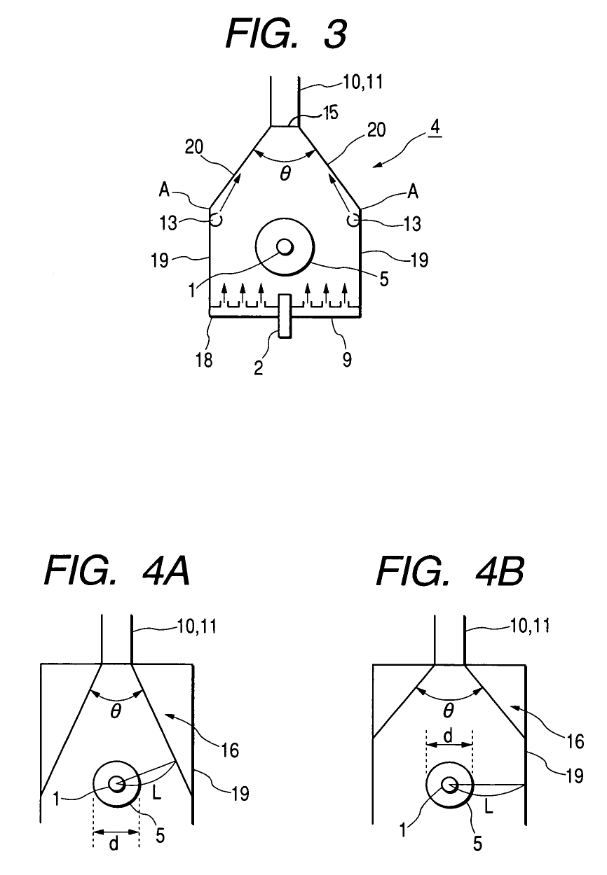

In the example of FIGS. 1 and 2, the fluid adjusting means 16 is composed of a pair of plate-shaped members for partitioning the reaction vessel 4 from the upper face to the lower face. However, there is no need that this fluid adjusting means 16 partitions the reaction vessel 4 totally from the upper face to the lower face. In particular, in the bottom portion of the reaction vessel 4 where the flow of fluid is calm, the fluid adjusting means 16 may not exist. Further, instead of separately placing the fluid adjusting means 16 within the reaction vessel 4, the reaction vessel 4 may have the shape composed of both side faces 19, 19 and two rear side faces 20, 20 formed between the side faces 19, 19 and the rear face 15, as shown in FIG. 3. In this case, the rear side faces 20 are employed as the wall faces of the fluid adjusting means 16.

Also, the apparatus for producing glass particles deposit according to this invention has gas ports 13 at positions closer to the face where the burners are placed than the mounting position in contact with the fluid adjusting means 16 on the side face 19, as shown in FIGS. 1 and 2. The gas ports 13 are installed symmetrically with respect to the plane containing central axes of the burners 2 and the rotational axis of the target rod 1. The gas ports 13 are directed toward the fluid adjusting means 16 on the same side, thereby blowing out the clean air or inert gas such as N₂ toward the gas adjusting means 16. With this flow of fluid, glass particles not deposited on the glass particles deposit are exhausted smoothly through the exhaust ports 10 and 11. From the experimental results, it was found that the gas ports 13 must be disposed as close to the fluid adjusting means 16 as possible to increase the exhaust efficiency.

Within the reaction vessel 4, it is required to form a uniform flow of fluid in a direction from the burners 2 to the exhaust ports 10 over the entire length of the target rod 1. Accordingly, it is desirable that the gas port 13 can blow out the gas uniformly at least over the entire length of the target rod 1. The gas port 13 can take arbitrary form in which a plurality of gas blowout holes or the long slits are arranged in parallel in a direction of the axis of the target rod 1. It is desirable that a gas blowout nozzle having a number of gas blowout holes for blowing the gas in the same direction is disposed in parallel to the rotation axis of the target rod 1, such that the gas blowout holes are directed toward the fluid adjusting means 16 on the same side. In any form, the flow velocity of gas blown out of each gas port 13 is desirably 30 m/minute or more.

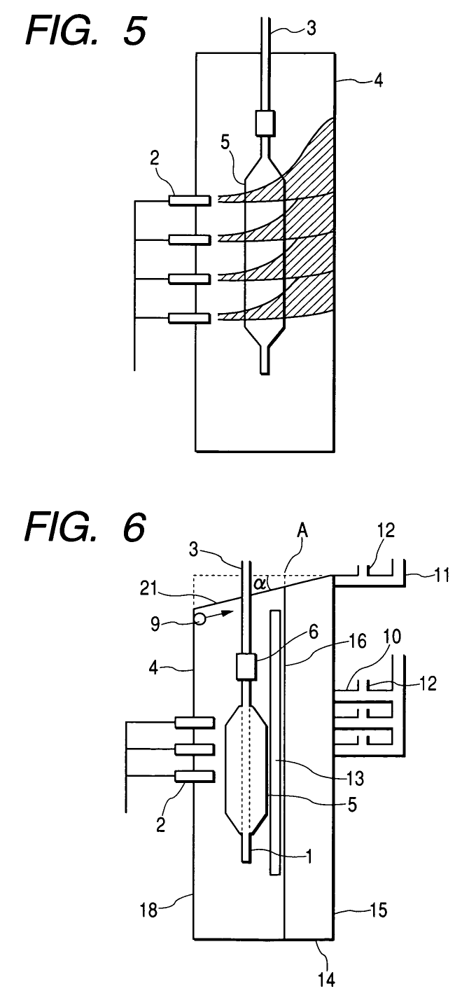

In the case where there no disturbance, the temperature within the reaction vessel 4 rises due to the heat generated in synthesizing glass particles. The gas within the reaction vessel 4 is heated, and flows upward. The glass particles are blown in this upward flow of fluid, and tend to move upward within the reaction vessel 4, as indicated by the hatching in FIG. 5. Therefore, it is desirable that at least one of the exhaust ports is placed above the installed positions of the burners.

In addition to the gas port 13 disposed near the side face 19 of the reaction vessel 4, a gas port 9 is desirably provided at an upper part of the reaction vessel 4. The gas port 9 is disposed above the holding means 6 of the target rod 1 and in parallel to the upper face of the reaction vessel 4, as shown in FIGS. 1 and 2. The construction and the gas blowout amount of the gas port 9 may be the same as those of the gas port 13.

The gas port 9 as shown in FIGS. 1 and 2 is disposed in parallel to the upper face 17 of the reaction vessel 4, and in parallel to the front face 18. The gas port 9 is a gas blowout nozzle with a plurality of gas blowout holes, which are directed in a direction parallel to the side face 19. A gas flow that is planar as seen from above the reaction vessel 4 is blown out of the gas port 9.

It is desirable that the upper structure of the reaction vessel has the upper face 21 of the reaction vessel 4 formed with an inclined face increasing in height at a constant rate toward the rear face 15 of the reaction vessel 4, as shown in FIG. 6. Moreover, at least one of the exhaust ports is desirably provided on an upper end portion of the rear face 15, like the exhaust port 11 of FIG. 6. Since the upper face 21 of the reaction vessel 4 gradually rises toward the exhaust port 11, glass particles do not remain on the upper portion of the reaction vessel 4, and are exhausted out of the exhaust port 11. Accordingly, the reaction vessel 4 can be maintained in the clean state more favorably. An inclination angle a of the upper face 21 of the reaction vessel 4 with respect to the face perpendicular to the rotation axis of the target rod 1 is preferably from 10° to 30°, and more preferably from 15° to 25°.

The producing apparatus of FIGS. 1 and 2 has a gas port 12 for pressure adjustment in each of the gas exhaust ports 10, 11. The gas port 12 for pressure adjustment can adjust the displacement of each exhaust port. With the gas port 12, the flow of gas becomes uniformly over the entire length of the target rod 1, thereby providing a uniformly shaped glass particles deposit.

Also, it is desirable that a gas heating unit such as a coiled heater (not depicted) for heating the gas to be supplied to the gas ports 9 and 13 is provided, and the heated gas is introduced into the reaction vessel. Thereby, it is possible to prevent fracture or peeling off from occurring in the glass particles deposited layer because the low temperature gas is introduced into the reaction vessel to change the temperature distribution of the glass particles deposit.

In the producing apparatus of FIG. 1, the gas blown out of the gas port 9 desirably consists of a transverse gas flow and a downward gas flow. The glass particles synthesized by the burners move upwards with the flow of fluid within the reaction vessel 4. The downward gas flow of the gas port 9 reduces rising glass particles. The transverse gas flow of the gas port 9 blows away the rising glass particles. In this manner, with the gas flow from the gas port 9, the glass particles adhering to the upper portion of the reaction vessel are reduced. Accordingly, it is possible to prevent the glass particles from adhering onto the upper portion of the reaction vessel and forming a lump that may be peeled off and may drop on the surface of the glass particles deposit being produced. In this manner, the quality of the glass particles deposit is maintained without degradation.

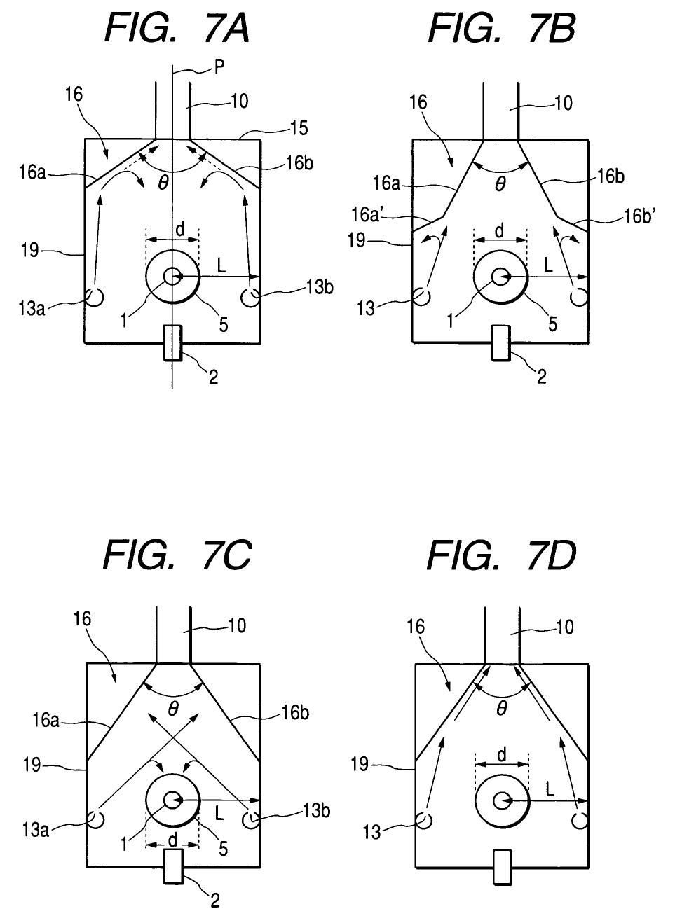

Referring to FIGS. 7A to 7D, the test results regarding the mounting position of the fluid adjusting means 16 and the flow state of fluid in the producing apparatus of the invention are described below. In FIGS. 7A to 7D, the reaction vessel 4 has a rectangular section, and the exhaust ports 10 are provided on the rear face 15 of the reaction vessel 4. The wall faces 16a and 16b of the fluid adjusting means 16 are composed of a pair of plate-shaped members for partitioning the reaction vessel 4, and extend from both sides of the exhaust ports 10 to be contact with the side face 19 of the reaction vessel 4. At the positions symmetrical with respect to the plane P including the central axes of the burners 2 and the rotation axis of the target rod 1, a pair of gas ports 13 are disposed near the side face 19. The gas ports 13 are disposed in the length direction of the target rod 1.

FIG. 7A is an example in which L is greater than d, but the contained angle θ of the fluid adjusting means 16 is beyond 90°. In this example of the above construction, if the gas is blown out from one gas port 13 to the wall face on the same side (e.g., from the gas port 13a to the wall face 16a), a part of the gas swirls. With this eddy of gas, there occurred a phenomenon that floating glass particle returned to the glass particles deposit 5, thereby making the smooth exhaust difficult.

FIG. 7D is an example in which the contained angle θ of the fluid adjusting means 16 is 90° or less, and L is greater than d. In the example of this construction, if the gas blown out from one gas port 13 to the wall face on the same side uniformly flows in the direction toward the exhaust ports 10, causing no eddy. Accordingly, floating glass particles were smoothly exhausted.

FIG. 7B is an example in which the wall faces 16a′ and 16b′ of the fluid adjusting means 16 on the side of the gas port 13 are bent outward, the contained angle θ of the wall faces 16a and 16b of the fluid adjusting means 16 on the side of the exhaust ports 10 is 90° or less, and L is greater than d. In the example of this construction, the fluid adjusting means 16 has four wall faces. There occurred an eddy flow on the side face 19 near the wall faces 16a′ and 16b′, impeding the smooth exhaust of the gas. Furthermore, FIG. 7C is an example in which the contained angle θ of the fluid adjusting means 16 is 90° or less, L is greater than d, and the gas from one gas port 13 is blown out toward the wall face on the side where the other gas port 13 is disposed (e.g., from the gas port 13a to the wall face 16b). In the example of this construction, there occurred an eddy flow near the central portion of the reaction vessel 4, thereby making the smooth exhaust of floating gas particulates difficult.

The invention has been described above mainly with regards to producing apparatus of the longitudinal type in which the glass particle synthesis burner and the target rod are relatively moved vertically, but may be applied to the producing apparatus of the transverse type.

### EXAMPLE 1

The glass particles deposit was produced, using the rectangular reaction vessel 4 as shown in FIGS. 1 and 2. The reaction vessel 4 had a length of 1000 mm and a width of 700 mm in cross section. Three burners 2 were installed at a spacing of 200 mm. Three exhaust ports 10 were installed at the same spacing as the burners. The lowest exhaust port was installed to be as high as the intermediate burner, and the exhaust port 11 was provided at the upper end of the reaction vessel. For the fluid adjusting means 16, a pair of plate-shaped members were placed in the longitudinal direction of the reaction vessel. The contained angle θ of the fluid adjusting means 16 was 80°. L as the shortest distance between the target rod 1 and the side face 19 of the reaction vessel was 350 mm in this case.

Two gas blowout nozzles were installed directly near the mounting position on the side face 19 at which the fluid adjusting means is contact with the side face 19. The gas blowout nozzles had 300 gas blowout holes having a diameter of 1 mm at a pitch of 5 mm. The gas blowout nozzle was installed so that the gas blowout holes were directed toward the middle of the wall face on the same side. The range where the glass particles deposit 5 being produced can reciprocate was contained in the range where the gas blowout holes existed. The gas blowout nozzle as the gas port 9 was provided above the holding means 6 of the target rod 1 for the reaction vessel 4 and in parallel to the upper face of the reaction vessel 4. The gas blowout nozzle had 140 gas blowout holes having a diameter of 1 mm at a pitch of 5 mm. The gas blowout holes were directed to blow out a planar gas flow in parallel to the upper face of the reaction vessel 4.

As the synthesizing conditions of the glass particles, glass raw material gas, hydrogen gas, oxygen gas and argon gas were supplied at a rate of 12 liters/minute in total from the burners, and the clean air at room temperature was introduced into the gas ports 9 and 13 at a flow rate of 1 liter/minute for each gas blowout hole. The volume of the reaction vessel 4 was 3000 liters, and the total gas displacement was 3000 liter/minute.

Under these conditions, the glass particles deposit having a length of 600 mm and a diameter of 200 mm was produced. No lump of glass particles adhered onto the inside of the reaction vessel dropped down. Though in one of ten produced glass particles deposits a fracture which was considered to be caused due to the introduced air at room temperature was observed, the glass particles deposit of excellent shape and smooth surface was obtained. The glass particles deposit without fracture was vitrified within a furnace held at high temperature, such as 1500°, so that the excellent preform without irregularities and bubbles could be obtained.

### COMPARATIVE EXAMPLE 1

The glass particles deposit was produced in the same way as in the example 1, except that the reaction vessel having a cross section as seen in FIGS. 7A, 7B and 7C was employed. It was observed that glass particles adhered within the reaction vessel and the lump of glass particle dropped down, while the glass particles deposit was being produced. The surface of obtained glass particles deposit had an outer shape of irregularities. This glass particles deposit was vitrified within the furnace held at high temperature. It was observed that the produced preforms had irregularities or bubbles which correspond to the irregularities of the glass particles deposit, and the all ten produced preforms were defective.

### EXAMPLE 2

The glass particles deposit was produced in the same way as in the example 1, except that the upper portion of the reaction vessel has the structure as shown in FIG. 6 (inclination angle α=20° for the upper face of the reaction vessel). In this case, the glass particles deposit of excellent shape and appearance was obtained without dropping of the lump of glass particles adhering within the reaction vessel. This glass particles deposit was vitrified within the furnace held at high temperature, whereby the excellent preforms without irregularities and bubbles could be obtained.

### EXAMPLE 3

The glass particles deposit was produced in the same way as in the example 1, except that the clean air introduced into the reaction vessel was heated at 200°. No fracture was observed in any of ten glass particles deposits produced. This glass particles deposit was vitrified within the furnace held at high temperature, whereby the excellent preforms without irregularities could be obtained.

### EXAMPLE 4

The glass particles deposit was produced using the reaction vessel having different shape of the inner face by varying the contained angle θ of FIG. 2. The contained angle θ was varied from 20° to 110°, and the other conditions were the same as in the example 1. Since it is difficult to increase the distance between the glass particles deposit and the wall face in a range of θ<30°, the glass particles deposit having a small diameter could be only obtained, which was inefficient. In a range of θ>90°, the exhaust efficiency was low, and the irregularities were observed on the surface of the glass particles deposit. In a range of 30°<θ<90°, the produced glass particles deposit and the preform obtained by vitrifying the glass particles deposit had no irregularities and were excellent.

With the apparatus for producing the glass particles deposit according to the invention, the flow of fluid within the reaction vessel is smooth, and the floating dusts including excess glass particles which have not been deposited on the glass particles deposit were exhausted efficiently and rapidly, whereby the excellent glass particles deposit without irregularities could be obtained. If the heated gas was blown out, it is possible to prevent the occurrence of fracture in the glass particles depositing due to introduced gas at low temperature.

1. A method for producing glass particles deposit, comprising the steps of:
holding a target rod within a reaction vessel;
synthesizing glass particles with a plurality of glass particle synthesis burners placed on a front face of said reaction vessel and directed toward an outer circumferential face of said target rod while moving said burners and/or said target rod in parallel to a rotation axis of said target rod;
providing at least one exhaust port on a rear face of said reaction vessel;
contacting a fluid adjusting means having two wall faces extending from both sides of said exhaust port with two side faces of said reaction vessel, with an angle between two planes, respective defined by said two wall faces, being 90° or less:
positioning a plurality of first gas ports
at positions symmetrical with respect to a plane containing central axes of said burners and said rotation axis of said target rod, and
between said front face of said reaction vessel and a plane containing both lines at which said side faces of said reaction vessel respectively contact said wall faces;
directing each of said gas ports toward a nearer wall face; and
depositing said glass particles onto said target rod to satisfy a flowing formula L>d, wherein
a shorter distance between a first shortest distance from said rotation axis of said target rod to the wall face is L, and
an outer diameter of said glass particles deposit having been deposited on said target rod is d.

2. The method of producing glass particles deposit according to claim 1, further comprising:
adjusting a displacement of gas through each exhaust port if a plurality of exhaust ports are provided.

3. The method of producing glass particles deposit according to claim 1, wherein a second gas port is positioned above a location at which said target rod is held on the front face of the reaction vessel and in parallel to an upper face of said reaction vessel.

4. The method of producing glass particles deposit according to claim 1, wherein at least one of said exhaust ports is at a position higher than a position where a highest burner is located.

5. The method of producing glass particles deposit according to claim 1, wherein an inclined upper face of said reaction vessel from the top of said front face of said reaction vessel to the top of said rear face of said reaction vessel increases in height at a constant rate; and
at least one of said exhaust ports is on an upper end portion of said rear face of said reaction vessel.

6. The method of producing glass particles deposit according to claim 1, further comprising:
supplying heated gas to said first gas ports.

7. The method of producing glass particles deposit according to claim 1, wherein the angle is 30 degrees or greater.

8. The method of producing glass particles deposit according to claim 1, wherein said two wall faces include a pair of plate-shaped members extending in a longitudinal direction of said reaction vessel.

9. The method of producing glass particles deposit according to claim 5, wherein an angle between said inclined upper face of said reaction vessel and a face perpendicular to said rotation axis of said target rod is not less than 10 degrees but not more than 30 degrees.

10. The method of producing glass particles deposit according to claim 3, further comprising:
supplying heated gas to said second gas port.
